(19) United States
(12) Patent Application Publication
(10) Pub. No.: US 2012/0209716 A1
(43) Pub. Date: Aug. 16, 2012

(54) METHOD AND APPARATUS FOR SERVING PROMOTIONS IN A LOW-POWER WIRELESS NETWORK

(76) Inventor: Patrick E. Burns, San Mateo, CA (US)

(21) Appl. No.: 13/396,739

(22) Filed: Feb. 15, 2012

Related U.S. Application Data
(60) Provisional application No. 61/463,216, filed on Feb. 15, 2011.

(51) Int. Cl. G06Q 30/02

(52) U.S. Cl. 705/14.64

(57) ABSTRACT

A first electronic device may begin communicating with a second electronic device in response to detecting that the second electronic device is within communication range of a low-power wireless interface of the first electronic device. The first device may receive, via the low-power wireless interface, information about a status and/or profile of the second electronic device. The first device may generate a promotion customized based on the received information. The low-power wireless interface 114 may communicate in conformance with ISO 18000-7. The first electronic device may send, via the low-power wireless interface information about a status and/or profile of the first electronic device to the second electronic device. The second electronic device may request a promotion based on the profile and/or status of the first electronic device.

### CLAIM OF PRIORITY

This patent application makes reference to, claims priority to and claims benefit from U.S. Provisional Patent Application Ser. No. 61/463,216 entitled “Method for Serving Advertisements in a Low Power Wireless Network” and filed on Feb. 15, 2011.

The above stated application is hereby incorporated herein by reference in its entirety.

### INCORPORATION BY REFERENCE

This patent application also makes reference to:

U.S. Provisional Patent Application Ser. No. 61/464,376 entitled “Advanced Communication System for Wide-Area Low Power Wireless Applications and Active RFID” and filed on Mar. 2, 2011;

U.S. patent application Ser. No. 13/267,640 entitled “Method and Apparatus for Adaptive Searching of Distributed Datasets” and filed Oct. 6, 2011;

U.S. patent application Ser. No. 13/270,802 entitled “Method and Apparatus for a Multi-band, Multi-mode Smartcard” and filed Oct. 11, 2011;

U.S. patent application Ser. No. 13/354,513 entitled “Method and Apparatus for Memory Management” and filed on Jan. 20, 2012;

U.S. patent application Ser. No. 13/354,615 entitled “Method and Apparatus for Discovering People, Products, and Services via a Localized Wireless Network” and filed on Jan. 20, 2012; and

U.S. Patent Application Ser. No. 13/396,708 entitled “Method and Apparatus for Plug and Play, Networkable ISO 18000-7 Connectivity” and filed on Feb. 15, 2012.

Each of the above-referenced applications is hereby incorporated herein by reference in its entirety.

### FIELD OF THE INVENTION

Certain embodiments of the invention relate to wireless networking. More specifically, certain embodiments of the invention relate to a method and apparatus for serving promotions in a low-power wireless network.

### BACKGROUND OF THE INVENTION

Existing methods and systems for advertising lack flexibility and customizability. Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for serving promotions in a low-power wireless network, substantially as illustrated by and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE DRAWINGS

FIG. 1A is a diagram illustrating an exemplary arrangement of devices operable to serve promotions using low-power wireless communications.

FIG. 1B is another diagram illustrating an exemplary arrangement of devices operable to serve promotions using low-power wireless communications.

FIG. 2 illustrates details of an exemplary electronic device operable to serve and/or receive promotions via a low-power wireless network.

FIG. 3A is a flowchart illustrating exemplary steps for push-based promotions in a low-power wireless network.

FIG. 3B is a flowchart illustrating exemplary steps for pull-based advertising in a low-power wireless network.

FIG. 4 is a flowchart illustrating exemplary steps for generating a promotions to be served in a low-power wireless network.

FIG. 5 is a flowchart illustrating exemplary steps for promotions propagation in a low-power wireless network.

FIG. 6 is a diagram illustrating an exemplary communication of status and/or profile information.

### DETAILED DESCRIPTION OF THE INVENTION

As utilized herein the terms “circuits” and “circuitry” refer to physical electronic components (i.e. hardware) and any software and/or firmware (“code”) which may configure the hardware, be executed by the hardware, and or otherwise be associated with the hardware. As utilized herein, “and/or” means any one or more of the items in the list joined by “and/or”. As an example, “x and/or y” means any element of the three-element set {(x), (y), (x, y)}. As another example, “x, y, and/or z” means any element of the seven-element set {(x), (y), (z), (x, y), (x, z), (y, z), (x, y, z)}. As utilized herein, the terms “block” and “module” refer to functions than can be implemented in hardware, software, firmware, or any combination of one or more thereof. As utilized herein, the term “exemplary” means serving as a non-limiting example, instance, or illustration. As utilized herein, the terms “e.g.,” and “for example,” introduce a list of one or more non- limiting examples, instances, or illustrations. As utilized herein, the term “promotion” may refer to advertisements, rebates, coupons, special offers, and the like.

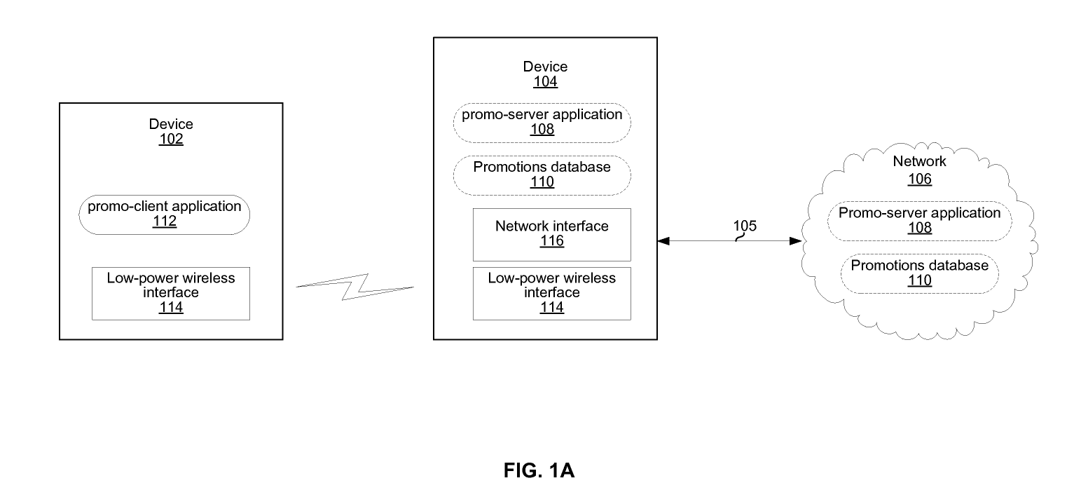

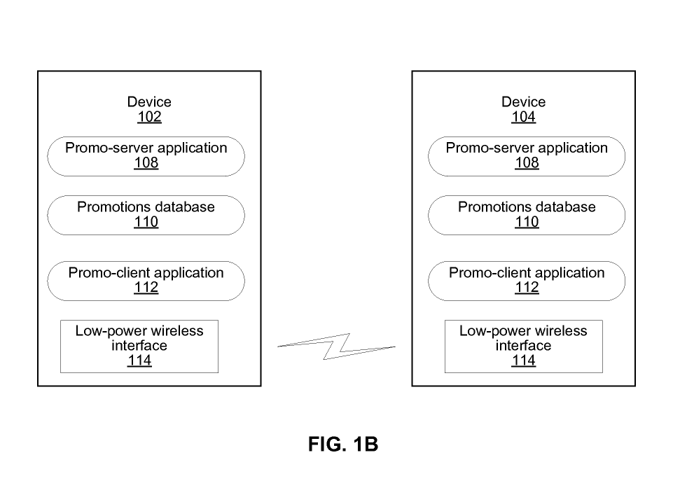

FIG. 1A is a diagram illustrating an exemplary arrangement of devices operable to serve promotions using low-power wireless communications. Referring to FIG. 1A there is shown devices 102 and 104 and a cloud 106 representing a network.

In an exemplary embodiment, the device 102 may be an end-user device such as, for example, a smartphone, an RFID tag, a laptop, or a tablet. In an exemplary embodiment of the invention, the device 104 may be an end-user device similar or the same as the device 102 and/or may be an access point and/or other device which resides in a public and/or commercial place. For example, the device 104 may be an access point which resides, for example, in a retail store, at a bus stop, on a bus, on a train, etc.

Each of the devices 102 and 104 comprise a low-power wireless interface 114. Each of the low-power wireless interfaces 114 comprise circuitry operable to communicate using one or more low-power wireless protocols such as protocols set forth in ISO 18000-7 and/or protocols set forth in above-incorporated U.S. Patent Application 61/464,376.

The device 104 may also comprise a network interface 116 which enables communicating via a wired or wireless link 105 to the network 106. Exemplary protocols which may be utilized by the interface 116 comprise Ethernet, WiFi, cellular protocols, Universal Serial Bus, etc.

In FIG. 1A, a promo-client application 112 is running on the device 102, a promo-server application 108 is running on the device 104 and/or the network 106, and a promotions database 110 is running on the device 104 and/or the network 106. In operation, the promo-client application 112 and the promo-server application 108 may exchange information regarding a status and/or profile of: the device 102, the device 104, a user of the device 102, and/or a user of the device 104. Based on the exchanged information, the promo-server application 108 may select and/or generate, utilizing the database 110, a promotion that is customized based on the status and/or profile of the device 102, a status and/or profile of a user of the device 102, and/or a status and/or profile of the device 104. The promo-server application 108 may then send the selected/generated promotion—or a link, token and/or other means of accessing the selected/generated promotion—to the promo-client application 112. The promo-client application 112 may receive the promotion, verify that the promotion is intended for the device 102 (and not some other device that is in communication range), and then present the promotion to a user of the device 102 (e.g., via a display and/or a speaker). Additional and/or alternative details of serving promotions via a low-power wireless connection are described below.

FIG. 1B is another diagram illustrating an exemplary arrangement of devices operable to serve promotions using low-power wireless communications. In FIG. 1B, each of the devices 102 and 104 are running a promo-server application 108, a promotions database 110, and a promo-client application 112. In this manner, promotions may be served both from device 102 to device 104 and from device 104 to the device 102. In an exemplary embodiment, each of the devices 102 and 104 may be operable to concurrently operate as a promo-serving device and a promo-receiving device and/or may be operable to switch between operation as a promo-serving device and promo-receiving device in a time-division-duplex manner. In an exemplary embodiment, the devices 102 and 104 may be operable to receive a promotion via its promo-client application 112, store the received promotion in its promotions database 110, and then send that promotion to another device via its promo-server application 108.

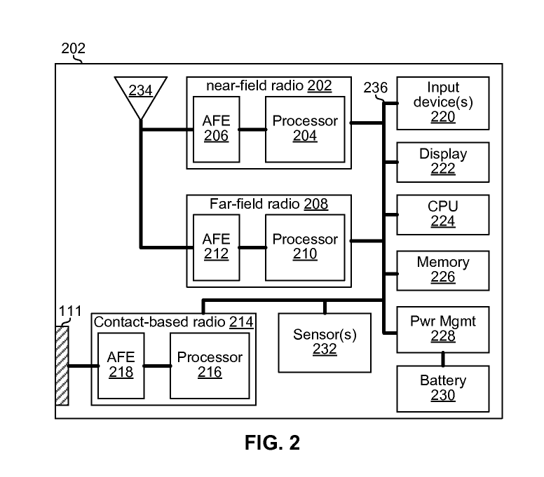

FIG. 2 illustrates details of an exemplary electronic device operable to serve and/or receive promotions via a low-power wireless network. The exemplary communication device 202 comprises a near-field radio 202, a far-field radio 208, a contact-based radio 214, input device(s) 220, a display 222, a central processing unit (CPU) 224, a memory 226, a power management module 228, a battery 230, one or more sensors 232, and an antenna 234. Each of the devices 102 and 104 shown in FIGS. 1A and 1B may comprise some or all of the components of the exemplary device 202 shown in FIG. 2.

The near-field radio 202 may comprise circuitry operable to communicate in accordance with one or more near-field communication protocols. For example, the near-field radio 202 may comprise an analog front-end (AFE) 206 and a processor 204 operable to communicate in accordance with one or more near-field protocols (e.g., protocols specified in ISO 18092, ISO 14443, and/or ISO 18000-3). The processor 204 may comprise circuitry operable to interface with the AFE 206 to receive and transmit data, and to process received and to-be-transmitted data. For transmission, the processor 204 may be operable to receive data via the bus 236, packetize and/or otherwise process the data to prepare it for transmission in accordance with one or more near-field protocols, and output the data to the AFE 206 for transmission. For reception, the processor 204 may be operable to receive data via the AFE 206, process the received data and output received data onto the bus 236.

The far-field radio 208 may comprise circuitry operable to communicate in accordance with one or more near-field communication protocols. For example, the far-field radio 208 may comprise an analog front-end (AFE) 212 and a processor 210 operable to communicate in accordance with one or more far-field protocols The processor 210 may comprise circuitry operable to interface with the AFE 212 to receive and transmit data, and to process received and to-be-transmitted data. For transmission, the processor 210 may be operable to receive data via the bus 236, packetize and/or otherwise process the data to prepare it for transmission in accordance with one or more far-field protocols, and output the data to the AFE 212 for transmission. For reception, the processor 210 may be operable to receive data via the AFE 212, process the received data and output received data onto the bus 236. In an exemplary embodiment, the far-field radio 208 may perform the functions of the low-power wireless interface 114 described with respect to FIGS. 1A and 1B. Accordingly, the far-field radio may support protocols specified in ISO 18000-7 and/or protocols set forth in the above-incorporated U.S. Provisional Patent Application 61/464,376 filed on Mar. 2, 2011. In an exemplary embodiment, the far-field radio 208 may perform functions of the network interface 116 described with respect to FIGS. 1A and 1B. Accordingly, the far-field radio 208 may support additional wireless protocols such as, for example, cellular protocols, WiFi, WiMAX, and/or Global Positioning System (GPS).

The contact-based radio 214 may comprise circuitry operable to communicate in accordance with one or more near-field communication protocols. For example, the contact-based radio 214 may comprise an analog front-end (AFE) 218 and a processor 216 operable to communicate in accordance with one or more near-field protocols (e.g., protocols specified in ISO 7816). The processor 216 may comprise circuitry operable to interface with the AFE 218 to receive and transmit data, and to process received and to-be-transmitted data. For transmission, the processor 216 may be operable to receive data via the bus 236, packetize and/or otherwise process the data to prepare it for transmission in accordance with one or more near-field protocols, and output the data to the AFE 218 for transmission. For reception, the processor 216 may be operable to receive data via the AFE 218, process the received data and output received data onto the bus 236.

The input device(s) 220 may comprise circuitry operable to receive input from a user of the device 202 and convert the input to digital signals. For example, the input device(s) 220 may comprise one or more hard and/or soft buttons and/or a touchscreen.

The display 222 may comprise circuitry operable to output visual signals to a user of the communication device 202. For example, the display 222 may be an OLED or bistable electrophoretic type display.

The CPU 224 may comprise circuitry operable to control operation of the device 202. The CPU 224 may, for example, execute an operating system and/or other programs. The CPU 224 may generate one or more control signals for controlling the operation of the device 202. The CPU 224 may, for example, control a mode of operation of the device 202.

Circuitry of the memory 226 may comprise one or more memory cells and may be operable to store data to the memory cell(s) and read data from the memory cell(s). The one or more memory cells may comprise one or more volatile memory cells and/or one or more non-volatile memory cells. In an exemplary embodiment, the memory 226 may store the database 110, promotions, links to promotions, cookies, and/or other information received from another device.

The power management module 228 may comprise circuitry operable to manage power allocation and/or power consumption in the communication device 202. The power management module 228 may be operable to, for example, dim and/or turn off the display when it is not needed, turn off one or more of the sensors 232 when not needed, and/or turn off the input device(s) 220 when not needed. Additionally and/or alternatively, the power management module 208 may control charging of the battery 230. For example, the power management module 208 may comprise an energy harvesting circuitry (e.g., to harvest solar energy, kinetic energy, and/or energy inductively coupled to the power management module 228) for charging the battery 208 and/or powering various components of the communication device 202. Additionally and/or alternatively, the power management module 208 may be operable to charge the battery 208 and/or power various components of the communication device 202 via energy received via the contacts 111. In an exemplary embodiment of the invention, certain components and/or functions of the communication device 202 may be disabled when the communication device 202 is not receiving power via, for example, inductive coupling and/or the contact(s) 111, and may be enabled when the communication device 202 is receiving power via, for example, inductive coupling and/or the contact(s) 111.

The battery 230 may, for example, a thin film and/or coin cell battery. In an exemplary embodiment of the invention, the battery may be as described in the above-incorporated U.S. Provisional Patent Application 61/404,842 filed on Oct. 12, 2010.

The sensor(s) 232 may comprise circuitry operable to detect conditions and/or events that trigger actions by the device 202. The sensors) 232 may comprise, for example, environmental sensors operable to sense temperature and/or humidity. As another example, the sensor(s) 232 may comprise be operable to sense acceleration, vibration, and/or other types of movement.

The antennas 234 may be operable to transmit and receive electromagnetic signals in one or more frequency bands. In an embodiment of the invention, the antenna 234 may be operable to transmit and receive signals in the ISM frequency band centered at 433.92 MHz and in the ISM frequency band centered at 13.56 MHz.

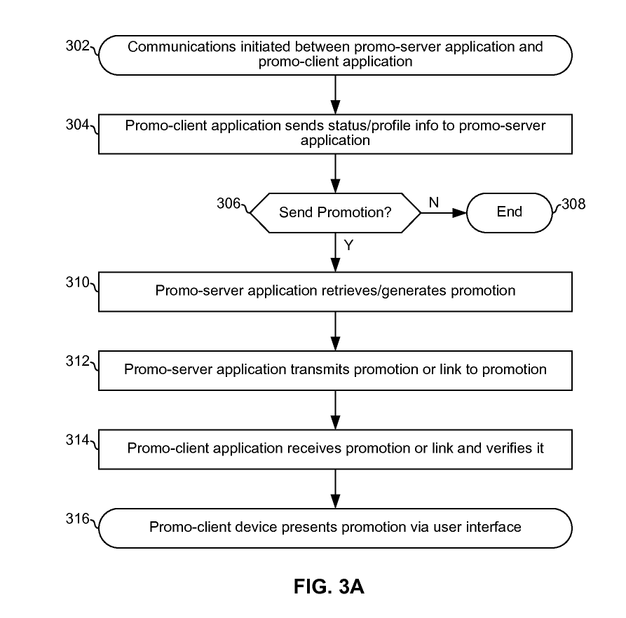

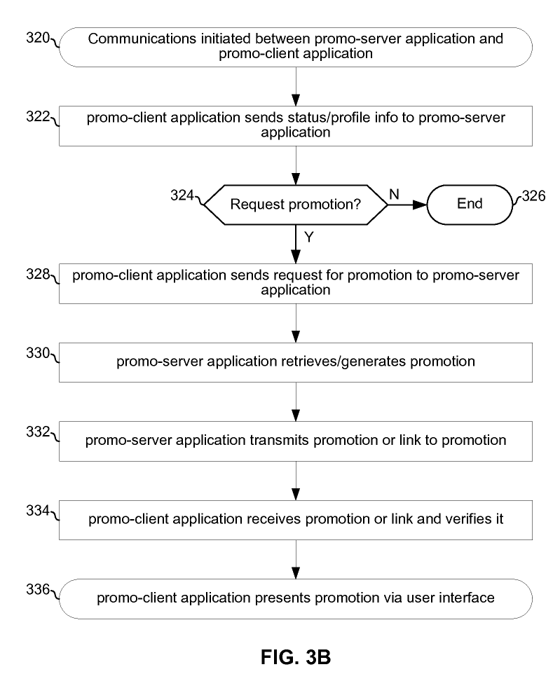

FIG. 3A is a flowchart illustrating exemplary steps for push-based promotions in a low-power wireless network. The exemplary steps begin with step 302 when communications are triggered between the promo-client application 112 running on the device 102 and the promo-server application 108 running on the device 104 and/or on a device in the network 106. The communications may be triggered in response to an event and/or condition internal and/or external to the device 102 and/or the device 104. The communications may be triggered by, for example: powering up and/or down components of the device 102 and/or the device 104, applications and/or processes in-use on the device 102 and/or the device 104, interrupts generated by such processes and/or applications, a state of such processes and/or applications, activities of the user of the device 102 and/or the user of the device 104, based on outputs from the sensor(s) 232, a location of the device 102 and/or the device 104 (e.g., determined by a GPS function of the radio 208, determined based on a WiFi, cellular, and/or other access point in range of the radio 208, and/or other methods), a distance between the devices 102 and 104 (e.g., as measured by one or more of the radios 202, 208, and 214), power available to the device 102 and/or the device 104 (e.g., battery charge and/or an indicator of whether the device is plugged-in), a wake-up signal or other alert received via one or more of the radios 202, 208, and 214.

In step 304, the promo-client application 112 running on the device 102 may send information regarding a status and/or profile of the device 102 and/or a user of the device 102 to the device 104. Such status and/or profile information may comprise, for example: wireless communication protocols supported by the device 102, wireless communication links currently available to the device 102, a hardware model of the device 102, a hardware configuration of the device 102, hardware constraints of the device 102, an operating system of the device 102, applications installed on the device 102, applications running on the device 102, a screen resolution of the device 102, a screen type of the device 102, an available viewing space on the screen of the device 102, a log file of a configuration history of the device 102, a log file of promotions (identified by token, by characteristics, by time and/or date of viewing, etc.) previously received and/or clicked-on by the device 102, information about tracking cookies residing on the device 102 (e.g., indicating which websites the device 102 has visited and/or which promotions it has previously received), a log file of other devices that have previously interacted with the device 102, a “blacklist” of devices (identified specifically and/or by status and/or profile) that the device 102 should not interact with, a list of devices (identified specifically and/or by status and/or profile) that the device 102 should interact with, GPS coordinates and/or other information about the location of the device 102, (short message service), multimedia message service (MMS), email, telephone, and/or other messaging/communication capabilities of the device 102, keywords generated by software running on the device 102 and/or input by a user of the device 102; information about a user's membership in certain social networks and/or organizations, “opt-in” status of the device 102 and/or its user for certain promotional programs, whether and/or how the device 102 is moving, an identity of the user, owner, carrier, and/or other entities associated with the device 102, a type and/or speed of wireless and/or wired network connections available to the device 102, environmental conditions within and/or surrounding the device 102, preferences of a user, owner, carrier and/or other entity associated with the device 102.

In step 306, the promo-server application 108, running on the device 104 and/or in the network 106, may determine whether to send a promotion to the device 102 based on the information received in step 304. If the promo-server application 108 determines not to send the promotion (e.g., because the received information indicated that the device 102 was not currently capable or interested in receiving a promotion, then in step 308 the exemplary steps of FIG. 3A are complete.

Returning to step 306, if the promo-server application 108 decides to send a promotion to the device 102, then the exemplary steps may advance to step 310.

In step 310, promo-server application 108 may retrieve and/or generate a promotion based on the information received in step 304. In an exemplary embodiment, the promo-server application 108 may retrieve a pre-generated promotion from the database 110. In an exemplary embodiment, the promo-server application 108 may not retrieve the promotion itself but may retrieve a uniform resource locator, token, and/or other information that, when communicated to the device 102, enables the device 102 to retrieve the promotion itself. In an exemplary embodiment, the promo-server application 108 may retrieve promotion content from the database 110 and render a promotion from the retrieved content.

By utilizing the received status and/or profile information, the promotion may be customized to the device 102 rather than just sending out generic and/or broadcast promotions that appear the same to every recipient. Fields (e.g., text or image fields) of the promotion may be populated with information that is more relevant and/or better suited to the device 102, its location, and/or its user based on the information received in step 304. For example, whether images or video are utilized in the promotion and, if so, a resolution of the images and/or video may be controlled based on the information received in step 304. As another example, the promotion may be customized based on which promotions the device 102 has previously received and/or clicked on (e.g., as indicated by cookies stored on the device 102).

In addition, or as an alternative, to customizing the promotion based on the status and/or profile information received from the device 102, the promotion may also be customized based on previous devices and/or previous promotions served by the device 104. For example, the promotion may be customized based on which types of promotions, goods, and/or services have had the most success (e.g., the most “click through”) when sent by the device 104. As another example, the promotion may be customized based on which content, products, and/or services are currently popular in the area (e.g., based on information received by the device 104 from multiple devices over a given time period).

In step 312, the promotion, or link thereto, retrieved/generated in step 310 is transmitted via the low-power wireless interface 114. In an exemplary embodiment, the promo-server application 108 may also transmit a tracking cookie to be stored on the promo-receiving device 102. The cookie may identify, for example, the promotion sent, the time it was sent, where it was sent from, etc.

In step 314, the promo-client application 112 receives the promotion or link and may verify that it is intended for the device 102. In an exemplary embodiment, the promo-client application 112 may also receive and store a tracking cookie sent by the promo-server application 108.

In step 316, the promo-client application 112 presents the promotion via a display and/or speakers of the device 102. In instances where a link or token was transmitted, the promo-client application 112 may retrieve the promotion from the network 106 (e.g., via cellular and/or WiFi capabilities of the radio 208) prior to presenting the promotion.

FIG. 3B is a flowchart illustrating exemplary steps for pull-based advertising in a low-power wireless network. The exemplary steps begin with step 320 when communications are triggered between the promo-client application 112 running on the device 102 and the promo-server application 108 running on the device 104 and/or in the network 106. The communications may be triggered in response to an event and/or condition internal and/or external to the device 102 and/or the device 104. The communications may be triggered by, for example: powering up and/or down components of the device 102 and/or the device 104, applications and/or processes in-use on the device 102 and/or the device 104, interrupts generated by such processes and/or applications, a state of such processes and/or applications, activities of the user of the device 102 and/or the user of the device 104, based on outputs from the sensor(s) 232, a location of the device 102 and/or the device 104 (e.g., determined by a GPS function of the radio 208, determined based on a WiFi, cellular, and/or other access point in range of the radio 208, and/or other methods), a distance between the devices 102 and 104 (e.g., as measured by one or more of the radios 202, 208, and 214), power available to the device 102 and/or the device 104 (e.g., battery charge and/or an indicator of whether the device is plugged-in), a wake-up signal or other alert received via one or more of the radios 202, 208, and 214.

In FIG. 322, the promo-server application 108, running on the device 104 and/or in the network 106, may send information regarding a status and/or profile of the device 104 to the device 102. In an exemplary embodiment, the status and/or profiles may be sent in response to a query from the promo-client application 112. Such status and/or profile information may comprise, for example: companies, organizations, or other advertisers associated with the device 104, a hardware model of the device 104, a hardware configuration of the device 104, hardware constraints of the device 104, an operating system of the device 104, applications installed on the device 104, applications running on the device 104, a screen resolution of the device 104, a screen type of the device 104, an available viewing space on the screen of the device 104, a log file of a configuration history of the device 104, a log file of promotions (identified by token, by characteristics, by time and/or date of viewing, etc.) previously received and/or clicked-on by the device 104, information about tracking cookies residing on the device 104, a log file of other devices that have previously interacted with the device 104, a “blacklist” of devices (identified specifically and/or by status and/or profile) that the device 104 should not interact with, a list of devices (identified specifically and/or by status and/or profile) that the device 104 should interact with, GPS coordinates and/or other information about the location of the device 104, (short message service), multimedia message service (MMS), email, telephone, and/or other messaging/communication capabilities of the device 104, keywords generated by software running on the device 104 and/or input by a user of the device 104; information about a user's membership in certain social networks and/or organizations, “opt-in” status of the device 104 and/or its user for certain promotional programs, whether and/or how the device 104 is moving, an identity of the user, owner, carrier, and/or other entities associated with the device 104, a type and/or speed of wireless and/or wired network connections available to the device 104, environmental conditions within and/or surrounding the device 104, preferences of a user, owner, carrier and/or other entity associated with the device 104.

In step 328, the promo-client application 112 on the device 102, may determine whether to request a promotion from the promo-server application 108 based on the information received in step 322. The decision as to whether to request a promotion may be based on the information received in step 322 and/or based on a status and/or profile of the device 102. If the promo-client application 112 determines not to request the promotion (e.g., because the received information indicated that the device 104 did not have any promotions of interest to the device 102,) then in step 326 the exemplary steps of FIG. 3A are complete.

Returning to step 324, if the promo-client application 112 decides to request a promotion from the promo-server application 108, then the exemplary steps may advance to step 328.

In step 328, the promo-client application 112 transmits a request for a promotion. In an exemplary embodiment, the request may be sent via the radio 208, the radio 202, and/or the radio 214. In an exemplary embodiment of the invention, the request may comprise status and/or profile of the device 102 and/or its user.

In step 330, promo-server application 108 may retrieve and/or generate a promotion based on the request received in step 328 and/or based on the profile and/or status of the device 104. In an exemplary embodiment, the promo-server application 108 may retrieve a pre-generated promotion from the database 110. In an exemplary embodiment, the promo-server application 108 may not retrieve the promotion itself but may retrieve a uniform resource locator, token, and/or other information that, when communicated to the device 102, enables the device 102 to retrieve the promotion itself. In an exemplary embodiment, the promo-server application 108 may retrieve promotion content from the database 110 and render a promotion from the retrieved content. In this manner, the promotion may be more customized for the device 102 and/or the device 104 than the pre-generated promotion. Fields (e.g., text or image fields) of the promotion may be populated with information that is more relevant and/or better suited to the device 102 and/or the device 104, to the location of the device 102 and/or the device 104, and/or to the preferences of the user of the device 102 and/or the device 104 based on: the request received in step 328, the profile and/or status of the device 102, and/or the profile and/or status of the device 104. For example, whether images or video are utilized in the promotion and, if so, a resolution of the images and/or video may be controlled based on the information received in step 304.

In step 332, the promotion, or link thereto, retrieved/generated in step 330 is transmitted via the low-power wireless interface 114. In an exemplary embodiment, the promo-server application 108 may also transmit a tracking cookie to be stored on the promo-receiving device 102. The cookie may identify, for example, the promotion sent, the time it was sent, where it was sent from, etc.

In step 334, the promo-client application 112 receives the promotion or link and may verify that it was intended for the device 102. In an exemplary embodiment, the promo-client application 112 may also receive and store a tracking cookie sent by the promo-server application 108.

In step 336, the promo-client application 112 presents the promotion via a display and/or speakers of the device 102. In instances where a link or token was transmitted, the promo-client application 112 may retrieve the promotion from the network 106 (e.g., via cellular and/or WiFi capabilities of the radio 208) prior to presenting the promotion.

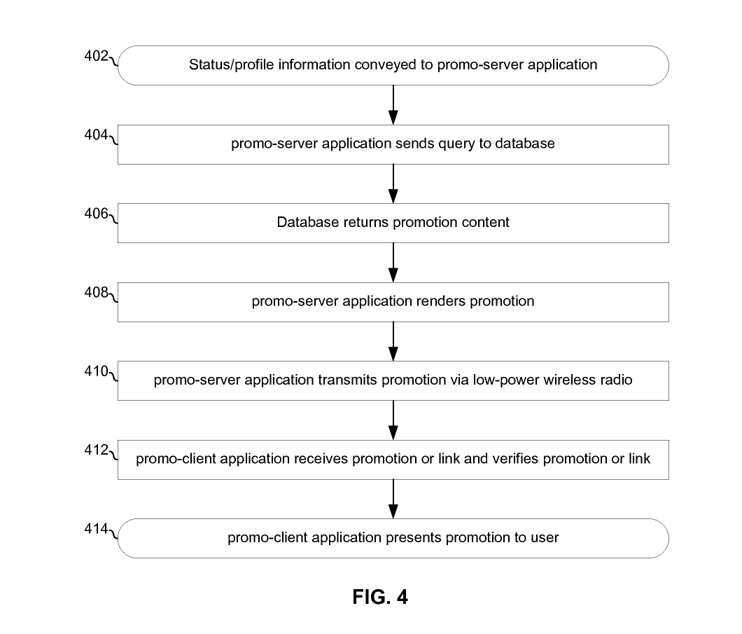

FIG. 4 is a flowchart illustrating exemplary steps for generating a promotion to be served in a low-power wireless network. In step 402 status and/or profile information of: the device 102, a user and/or owner of the device 102, the device 104, and/or a user and/or owner of the device 104 may be conveyed to the promo-server application 108.

In step 404, the promo-server application 102 generates one or more queries based on the status and/or profile information and submits the queries to the database 110.

In step 406, the database 110 returns content for generating a promotion. The content may comprise, for example, images, text fields, hyperlinks, and/or any other objects which may, for example, appear on a web-based promotion.

In step 408, the promo-server application 108 may utilize the retrieved content to generate a promotion customized for the device on which the promo-client application 112 is running.

In step 410, the promo-server application 108 transmits (e.g., utilizing ISO 18000-7) the generated promotion and/or a link or token that enables access to the generated promotion. In the latter case, the generated promotion may, for example, be stored on a server as an HTML file, and a link to the HTML file may be transmitted.

In step 412, the promo-client application 112 receives the promotion, or the link to the promotion, and verifies that it is the intended recipient of the promotion/link.

In step 414, the promo-client application 112 presents the received promotion. Where a link was received in step 412, then step 416 comprises first fetching the promotion via the received link, and then presenting the promotion. In an exemplary embodiment, the promo-client application 112 may fetch the promotion via any available wireless link. For example, the promotion may be fetched via the low-power wireless interface 114 or via a WiFi or other interface having greater range and/or bandwidth than the low-power interface 114. In some instances, the device 102 may wait to fetch the promotion until a higher-bandwidth link is available.

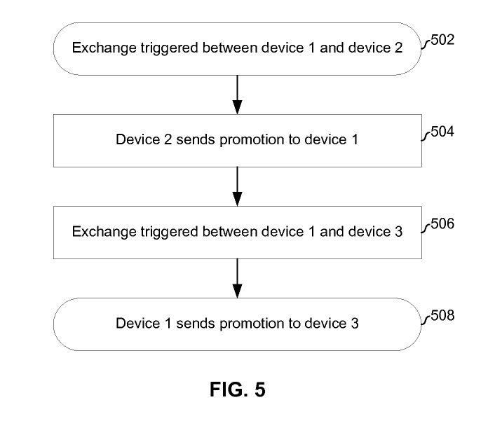

FIG. 5 is a flowchart illustrating exemplary steps for promotion propagation in a low-power wireless network. In step 502 an exchange of communications is triggered between devices 102 and 104. In step 504, a promo-serving application running on device 104 sends a promotion to a promo-client application running on device 102. In step 506, an exchange is triggered between device 102 and a third device. In step 508, a promo-server application running on the device 102 sends the promotion received in step 504 to a promo-client application running on the third device.

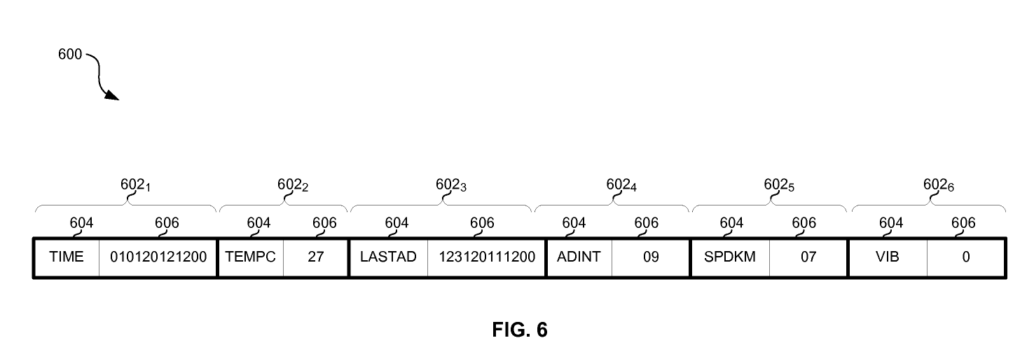

FIG. 6 is a diagram illustrating an exemplary communication of status and/or profile information. Status and/or profile information may be communicated between devices in the form of a unique marketing code (UMC) which may be, for example, a file, a script, or a program generated based on status and/or profile information generated, measured, etc. by the sending device. An exemplary UMC 600 is shown in FIG. 6. The UMC 600 comprise a plurality of elements 602, each comprising type field 604 and a value field 606. Each type field 604 comprises an alphanumeric descriptor identifying the type of element that is being communicated, and each value field 605 comprises the corresponding value. A List of valid type descriptors and the expected format of their corresponding value fields may, for example, be predetermined and/or set forth in a template stored in the devices.

The exemplary fields and values of the UMC 600 are as follows.

Element 602₁ is of type TIME and indicates the time at which the UMC was transmitted. The corresponding value field 606 contains a value of 010120121200 indicating that the UMC 600 was sent at 12:00 PM on Jan. 1, 2012.

Element 602₂ is of type TEMPC and indicates the internal or external temperature of the sending device. The corresponding value field 606 contains a value of 27 indicating a temperature of 27° Celsius.

Element 602₃ is of type LASTAD and indicates the last time a promotion was presented on the sending device. The corresponding value field 606 contains a value of 123120111200 indicating that the send device last presented a promotion at 12:00PM on Dec. 31, 2011.

Element 602₄ is of type ADINT and indicates, on a scale of 1 to 10, how interested the sending device and its user are in receiving promotions at the time of sending the UMC 600. The corresponding value field 606 contains a value of 9, indicating that there is currently a high level of interest in receiving promotions.

Element 602₅ is of type SPDKM and indicates a speed at which the sending device is traveling in kilometers per hour. The corresponding value field 606 contains a value of 7, indicating that the device sending the UMC 300 is traveling at 7 kilometers per hour.

Element 602₆ is of type VIB and indicates whether the sending device is vibrating. The corresponding value field 606 contains a value of 0, indicating that the device sending the UMC 300 is not currently vibrating.

In accordance with various aspects of the present invention, a first electronic device 102 may begin communicating with a second electronic device 104 in response to detecting that the second electronic device 104 is within communication range of a wireless interface 114 of the first electronic device 102. The first device 104 may receive, via the wireless interface 114, information about a status and/or profile of the second electronic device 102. The first device 104 may generate a promotion customized based on the received information. The wireless interface 114 may communicate in conformance with ISO 18000-7. The promotion may be transmitted via the wireless interface 114. The first electronic device 104 may transmit a uniform resource locator (URL) that enables retrieving the promotion via the Internet. The detecting may be based on output of a sensor 232 (e.g., environmental, location, and/or a motion sensor) residing in the first electronic device 104, and/or on radio frequency (RF) energy incident on the first electronic device. For example, communications may be triggered when received signal strength on a particular frequency band is above a threshold. As another exemplar, communications may be triggered when a particular signal or sequence of signals is received on a particular frequency channel (e.g., a beacon signal). The promotion may be customized based, at least in part, on information previously received by the first electronic device 104 from a third electronic device. For example, the device 104 may collect information and/or generate statistics over time and utilize these statistics and aggregated information in customizing the promotion. Exemplary statistics may comprise, for example: what promotions and/or other content is currently popular in the area, which particular promotions and/or types of promotions are generating “click-throughs,” etc. The generation of the promotion may comprise querying a database 110 that is stored in memory 226 of the first electronic device 104. The generation of the promotion may comprise querying a database 110 that is stored in one or more devices (e.g., servers, access points, and/or end-user devices) of a network 106 and the query may be submitted via a wired or wireless connection 105 to the network 106. The generation of the promotion may comprise, for example, selecting each of a plurality of objects based on the received information, and combining the selected objects. The objects may be, for example, links, image files, video files, and/or audio files.

In accordance with various aspects of the present invention, a first electronic device 102 may begin communicating with a second electronic device 104 in response to detecting that the second electronic device 104 is within communication range of a first wireless interface 114 of the first electronic device 102. The first device 102 may transmit, via the first wireless interface 114, information about a status and/or profile of the first electronic device 102 and/or its user, and present, via a user interface of the first electronic device 102 (e.g., display and/or speakers), a promotion that is customized based on the transmitted information. The first wireless interface 114 may communicate in conformance with ISO 18000-7. The first electronic device 102 may receive the promotion via the first wireless interface 114. The promotion may be transmitted in the form of an HTML and/or XML file. The first electronic device 102 may receive, via the first wireless interface 114, a uniform resource locator (URL) that enables retrieving the promotion via the Internet. The first electronic device 102 may utilizing the URL to retrieve the promotion from the Internet via a second wireless interface (e.g., WiFi interface) of the first electronic device 102. The detecting may be based on output of a sensor 232 (e.g., environmental, location, and/or a motion sensor) residing in the first electronic device 102 and/or on radio frequency (RF) energy incident on the first electronic device. For example, communications may be triggered when received signal strength on a particular frequency band is above a threshold. As another exemplar, communications may be triggered when a particular signal or sequence of signals is received on a particular frequency channel (e.g., a beacon signal). The first electronic device 102 may receive, via the first wireless interface, information about a status and/or profile of the second electronic device 104, and may request the promotion from the second electronic device based on the information about a status and/or profile of the second electronic device. For example, the device 102 may learn that the device 104 is associated with a product or service that the user of the device 102 has indicated a preference for. The first electronic device 102 may detect that a third electronic device is within communication range of the first wireless interface 114 of the first electronic device 102, and may transmit the promotion to the third electronic device. In this manner, promotions may be propagated beyond the communication range of the device 104.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for serving promotions in a low-power wireless network.

Accordingly, the present invention may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method comprising:
in a first electronic device,
communicating with a second electronic device in response to detecting that said second electronic device is within communication range of a wireless interface of said first electronic device, wherein said communicating comprises receiving, via said wireless interface, information about a status and/or profile of said second electronic device; and
generating a promotion that is customized based on said received information.

2. The method of claim 1, wherein said wireless interface communicates in conformance with ISO 18000-7.

3. The method of claim 1, wherein said first electronic device transmits said promotion via said wireless interface.

4. The method of claim 1, wherein said first electronic device transmits a uniform resource locator (URL) that enables retrieving said promotion via the Internet.

5. The method of claim 1, wherein said detecting is based on output of an environmental sensor, a location sensor, and/or a motion sensor residing in said first electronic device.

6. The method of claim 1, wherein said detecting is based on radio frequency (RF) energy incident on said first electronic device.

7. The method of claim 1, comprising customizing said promotion based, at least in part, on information previously received by said first electronic device from a third electronic device.

8. The method of claim 1, wherein said generating said promotion comprises querying a database that is stored in memory of said first electronic device.

9. The method of claim 1, wherein said generating said promotion comprises querying a database that is stored in one or more devices of a network and said query is submitted via a wired or wireless connection to said network.

10. The method of claim 1, wherein said generating said promotion comprises selecting each of a plurality of objects based on said received information, and combining said selected objects.

11. A method comprising:
in a first electronic device,
communicating with a second electronic device in response to detecting that second electronic device is within communication range of a first wireless interface of said first electronic device, wherein said communicating comprises transmitting, via said first wireless interface, information about a status and/or profile of said first electronic device and/or its user; and
presenting, via a user interface of said first electronic device, a promotion that is customized based on said transmitted information.

12. The method of claim 11, wherein said first wireless interface communicates in conformance with ISO 18000-7.

13. The method of claim 11, wherein said first electronic device receives said promotion via said first wireless interface.

14. The method of claim 11, wherein said promotion is transmitted in the form of an HTML and/or XML file.

15. The method of claim 11, wherein said first electronic device receives, via said first wireless interface, a uniform resource locator (URL) that enables retrieving said promotion via the Internet.

16. The method of claim 15, comprising utilizing said URL to retrieve said promotion from the Internet via a second wireless interface of said first electronic device.

17. The method of claim 11, wherein said detecting is based on output of an environmental sensor, a location sensor, and/or a motion sensor residing in said first electronic device.

18. The method of claim 11, wherein said detecting is based on radio frequency (RF) energy incident on said first electronic device.

19. The method of claim 11, comprising:
receiving, via said first wireless interface, information about a status and/or profile of said second electronic device; and
requesting said promotion from said second electronic device based on said information about a status and/or profile of said second electronic device.

20. The method of claim 11, comprising:
detecting, in said first electronic device, that a third electronic device is within communication range of said first wireless interface of said first electronic device;
transmitting said promotion to said third electronic device.
